(19) United States
(12) Patent Application Publication
(10) Pub. No.: US 2007/0282993 A1
(43) Pub. Date: Dec. 6, 2007

(54) Distribution of system status information using a web feed

(75) Inventors: Andrew McMillan, Manchester, NH (US); Daniel Berry, Concord, NH (US)

Correspondence Address: BROMBERG & SUNSTEIN LLP, 125 SUMMER STREET, BOSTON, MA, 02110-1618, US

(73) Assignee: Teletrol Systems Inc.

(21) Appl. No.: 11/445,904

(22) Filed: Jun. 2, 2006

(51) Int. Cl. G06F 15/173

(52) U.S. Cl. 709/223

(57) ABSTRACT

Disclosed is a mechanism for notifying potential responders of a condition of a system. Status information is received in response to a condition in a system. The condition is of the type requiring notification of a potential responder—for instance, an alarm in a building energy management system. A status web feed is prepared in accordance with a web feed protocol. The status web feed includes content related to the status information. The status web feed is distributed to potential responders that subscribe to the status web feed. The web feed protocol may be for example RSS or ATOM.

### FIELD OF THE INVENTION

The present invention relates generally to the field of distribution of system status information, and particularly to distribution of system alarm information to potential responders.

### BACKGROUND OF THE INVENTION

Today's businesses employ many different types of systems that require monitoring and attention by responders. Computer systems, network systems, security systems, and the like are able to police themselves for failures or out-of-limit conditions. If such a condition is detected, the system can notify a responder of the condition. However, the notification process is not optimized for use by today's mobile responders.

For example, large buildings, such as stores, businesses, hotels, etc. employ energy management systems for controlling the building environment. Energy management systems are employed to automate such things as climate control systems, lighting, and building security. Sophisticated energy management systems may be employed in groups of buildings and controlled from a central point, such as a headquarters building. In this case, each building energy management system is connected to a central management system in the headquarters building via a communication network, such as a T1 line or DSL line.

When an energy management system detects a failure or an out-of-limit condition in any of the systems it controls, it generates an alarm related to the condition. In today's multi-building systems, the alarm can be sent via the network to the central management system and presented on a screen display there, where it can be observed and responded to by an operator using an application such as a web browser. But this mechanism requires that someone be present to observe the screen display. Alarms can alternately be sent to a cell phone, or pager, or e-mail on a PDA. But in order to notify mobile responders via a cell phone or other device, an e-mail alarm must be sent from a energy management system to an e-mail server at the central management system, and then relayed from the central e-mail server to the mobile responder. However, it is well known that e-mail relays present a significant security risk, and therefore e-mail relaying is often prohibited. There is a need for a secure means of notifying a mobile responder of the condition of a system.

### SUMMARY OF THE INVENTION

In accordance with the principles of the invention, methods, apparatus, and program products are provided for notifying potential responders of a condition of a system. Accordingly, status information is received in response to a condition in a system. The condition is of the type requiring notification of a potential responder. A status web feed is prepared in accordance with a web feed protocol. The status web feed includes content related to the status information. The status web feed is distributed to potential responders that subscribe to the status web feed.

The status information may be received via a first communication network. The status web feed may be distributed via the first communication network, or via a second communication network. The web feed protocol may be for example RSS or ATOM.

The invention is applicable for example in building energy management systems. Accordingly, a central energy management system is coupled to several building energy management systems via a first communication network. Alarm information is received by the central energy management system in response to a condition of a building energy management system via the first communication network. The condition is of the type requiring notification of a potential responder. An alarm web feed is prepared in accordance with a web feed protocol. The alarm web feed includes content related to the alarm. The alarm web feed is distributed to potential responders that subscribe to the alarm web feed. The alarm web feed may be distributed via the first communication network, or via a second communication network. The web feed protocol may be for example RSS or ATOM.

The invention provides an efficient and secure means of delivering status information related to conditions of systems to potential responders, regardless of the location of the responder.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a representation of building energy management systems coupled to a central energy management system in which the invention is employed.

FIG. 2 is a flow diagram representing the operation of a building energy management system of FIG. 1.

FIG. 3 is a flow diagram representing the operation of the central energy management system of FIG. 1 in accordance with the invention.

FIG. 4 is a representation of the system of FIG. 1 further showing third party server systems in the buildings.

FIG. 5 is a representation of a single building energy management system employing the invention.

FIG. 6 is a flow diagram representing the operation of the single building energy management system of FIG. 5 in accordance with the invention.

### DETAILED DESCRIPTION OF EXEMPLARY EMBODIMENTS

In accordance with the principles of the invention, a web feed is used to distribute status information related to the condition of a system. The condition is of the type requiring notification of a potential responder—for instance, a system alarm or a maintenance update. When one or more such conditions occur in a given system, a status web feed is prepared in accordance with a web feed protocol. The status web feed includes content related to the status information. The status web feed is distributed to potential responders that subscribe to the status web feed. One or more of the potential responders can then respond to the condition as required. An efficient and secure means of distributing status information to potential responders is thereby provided.

Web feeds provide web content and/or summaries of web content together with links to the full version of the content, and other metadata. Known web feed protocols for producing such feeds include but are not limited to RSS (http://blogs.law.harvard.edu/tech/rss, herein incorporated by reference) and ATOM (draft-ietf-atompub-protocol-08.txt, herein incorporated by reference). RSS, for example, delivers web information as an XML file called an RSS feed or RSS channel. Users subscribe to the RSS channel to view the RSS feed information via a client aggregator. Aggregators may be stand-alone software applications or applications built into web browsers, and can be implemented on laptops, cell phones, PDAs, and the like. The aggregator updates the user's display with new RSS feed when new information is available. As heretofore used, web feeds allow a website's frequent readers to track updates on the site as they occur. In contrast, as used in accordance with the invention, web feeds are used to push system status information to potential responders. System status information can thereby be distributed to potential responders, regardless of their location, without use of e-mail relays.

The invention can be employed in many types of systems. For example, the invention can be employed in computing, networking, and/or storage systems wherein status information related to conditions in a system must be monitored by potential responders. The invention is advantageously employed, for example, for distributing status information related to system alarms and/or maintenance updates. For instance, in a computing system, system alarms might indicate a server failure or unauthorized access or any number of adverse conditions. Maintenance updates might indicate that a maintenance time limit is expiring, or that an update is occurring, etc. According to the invention, information related to such an alarm or update is distributed via a web feed to subscribers of the web feed. One or more of the subscribers can then respond to the alarm or update.

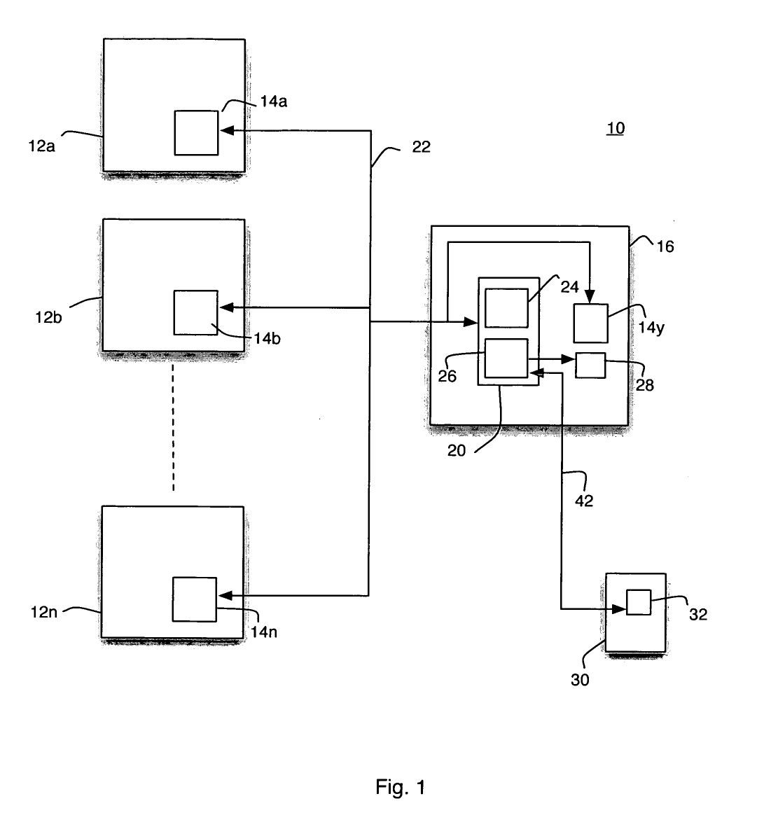

The invention is now described in detail as implemented in building energy management systems, with the understanding that it is applicable to many other types of systems including but not limited to those mentioned above. In FIG. 1 there is shown a hierarchical building energy management system 10 in which the principles of the invention are employed. Multiple buildings 12, herein shown individually as 12a-12n, employ corresponding building energy management systems 14, herein shown individually as systems 14a-14n. Each building energy management system 14 automates such things as climate control systems, lighting, and building security for its respective building 12. Examples of such building energy management systems are those provided by Teletrol Systems Inc., of Manchester, N.H., USA. A headquarters building 16 employs its own building energy management system 14 herein shown individually as 14y, and a central energy management system 20, from which all the building energy management systems 14a-14n can be controlled. The building energy management systems 14 are all coupled to the central energy management system 20 via a communication network 22, which may be for example a T1 line, a DSL line, an ATM network, an Ethernet network, or any other type of communication network. The communication network 22 may be dedicated or may employ the Internet.

For a given building such as building 12a, the building energy management system 14a controls building systems in response to pre-programmed settings or settings provided by a user via interaction with either the building energy management system 14a or the central energy management system 20. The building energy management system 14a continually monitors the building systems to ensure that the systems are operating properly. If the building energy management system 14a detects a system failure such as a component failure, or an out-of-limit condition such as excessively high temperature that does not respond to attempts to control it, the energy management system 14a generates an alarm related to the detected condition. The alarm is sent to the central energy management system 20 via the communication network 22.

The central energy management system 20 is shown to include a database server 24 and a web server 26. These servers may reside in separate computer systems, or may reside in a single computer system. The database server 24 is a repository for information related to the building energy management systems 14. The web server 26 is used by the central energy management system 20 to communicate status information to individuals who are responsible for managing the energy management systems 14. When the central energy management system 20 receives an alarm from one of the energy management systems 14, it updates the database server 24 as necessary, and uses the web server 26 to display information related to the alarm condition on a computer screen 28, for example via a web browser. A responder who happens to be present at the headquarters building 16 and observ the computer screen 28 can respond to the displayed alarm. In accordance with the principles of the invention, the central energy management system 20 also uses the web server 26 to send the alarm information via a web feed, so that the alarm can be observed by potential responders 30 who are not necessarily proximate to the computer screen 28 or even present at the headquarters building 16. The potential responders 30 can observe the web feed via an aggregator 32 on a cell phone, PDA, laptop, or the like.

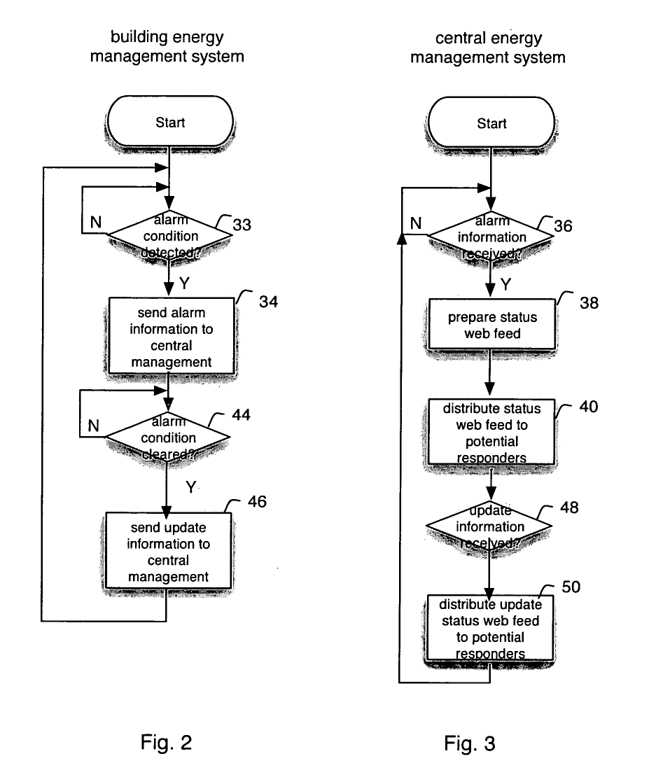

In accordance with a particular example and referring to FIGS. 1, 2, and 3, an alarm might be generated within the building energy management system 14b in response to an HVAC failure. As shown in FIG. 2, when the building energy management system 14b detects the alarm condition (step 33), the alarm, along with information identifying the failure and parameters associated with the failure, is sent via the communication network 22 to the central energy management system 20 (step 34). Referring to FIG. 3, when the web server 26 of the central energy management system 20 receives the alarm (step 36) from building energy management system 14b , it stores the alarm information in an alarm file available to the web server 26. The web server 26 implements a web feed protocol such as RSS or ATOM. The web feed program on the server points to the alarm file to produce an alarm entry for the status web feed (step 38), which in this case is an alarm web feed. The alarm web feed may include, for example, the type of alarm (HVAC failure) and a short summary of when and where the alarm condition has occurred, and an indication of the seriousness of the condition (i.e. warning, emergency), etc. Potential responders 30 in this example are individuals responsible for responding to building energy management system alarms 14. These potential responders 30 are subscribers to the alarm web feeds. When an alarm occurs, the alarm web feed is distributed to all potential responders who have subscribed to receive the alarm web feed (step 40) via a network 42. Potential responders 30 are alerted to the alarm by the aggregator 32 they are using. Thus, the web feed can be observed by mobile potential responders 30. One of the potential responders 30 can then respond as required to the alarm. Thus, the invention allows alarm information to be sent from a building energy management system 14 to a central energy management system 20 and then on to a mobile potential responder 30, without the need to relay information through an e-mail server. The invention thereby provides a secure mechanism for notifying a potential responder 30 of the alarm of an energy management system 14, regardless of the responder's location.

The network 42 used to distribute the status web feed to potential responders 30 may be any type of network, including wired or wireless. According to one implementation, the communication network 22 utilizes the Internet. In this case, the web feed can be distributed to the potential responders 30 via the same Internet network 22; thus, the communication network 22 and the network 42 are actually the same. According to another implementation, the communication network 22 is a private network. In this case, the network 42 is a separate network connection from the communication network 22.

According to a further aspect of the invention, referring to FIG. 2, once one of the potential responders 30 responds to the alarm and the building energy management system 14b detects that the alarm has been cleared (step 44), the building energy management system 14b can send an “alarm cleared” update message to the central energy management system 20 (step 46). Referring to FIG. 3, upon receipt of the update information (step 48), the central energy management system 20 can then distribute a status web feed to the potential responders 30 (step 50). This status web feed indicates that the alarm has been cleared.

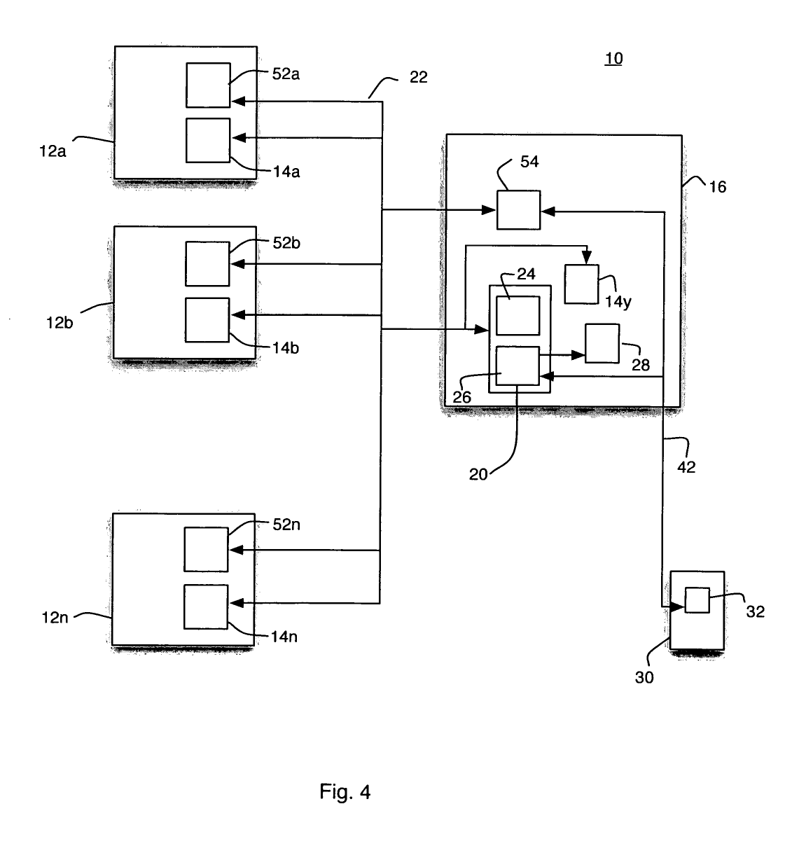

The invention is also advantageously employed in systems having multiple disparate managed systems. In FIG. 4 there is shown the buildings 12 and 16 of FIG. 1. Now each building 12 is shown to include a third party server system 52 (herein shown individually as 52a-52n) as well as its building energy management system 14. The third party server systems 52 may be for example security systems. The third party server systems 52 are all coupled to a central third party server 54 in the headquarters building 16 via the communication network 22. When a security breach occurs at a given building 12, an alarm is sent from the third party server system 52 to the central third party server 54. In accordance with the invention, the central third party server 54 also employs a web feed protocol. The central third party server 54 supplies a status web feed in the same manner as shown in FIG. 3. Potential responders 30 can now subscribe to web feeds of the central management web server 26 and the central third party server 54. A potential responder 30 now has a secure means of alarm notification from multiple disparate systems associated with the buildings 12.

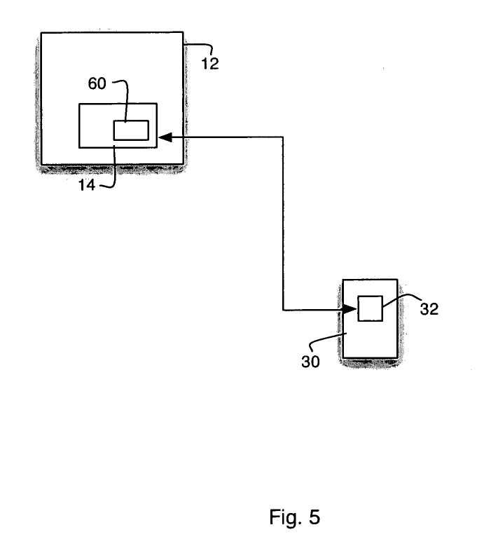

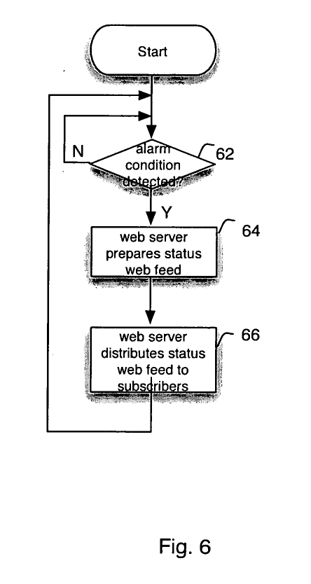

It should be noted that, although the invention has been described in terms of a hierarchical energy management system as shown in FIGS. 1 and 4, it can certainly be employed in a single building energy management system 14 for a single building 12 such as shown in FIG. 5. In this case, the building energy management system 14 includes a web server 60 that implements a web feed protocol. As shown in FIG. 6, when the building energy management system 14 detects an alarm condition (step 62), the web server 60 produces a status web feed related to the alarm (step 64). The web server 60 then distributes the web feed to all subscribed potential responders 30 (step 66). Potential responders 30 responsible for the building energy management system 14 can monitor the real time state of alarms for the building 12 via any aggregator 32 on any device that employs one.

The use of a web feed for distributing system status information is not limited to use with energy management systems and alarms. Web feeds can be employed to distribute real-time status information related to other types of system functions. For example, computing, network, and storage systems generate alarms for various conditions, such as certain types of failures, loss of redundancy, excessive usage, etc. Such alarms can be sent via a web feed to a person responsible for responding to such alarms. Furthermore, system status information besides alarms, such as maintenance updates, can be distributed as well.

Thus, the invention is generally applicable to distributing information related to the status of a system to potential responders responsible for monitoring and/or responding to the status of the system. The invention thus provides a novel means of distributing system status information in a secure, reliable manner.

The present invention is not to be limited in scope by the specific embodiments described herein. Various modifications of the present invention, in addition to those described herein, will be apparent to those of ordinary skill in the art from the foregoing description and accompanying drawings. One skilled in the art will understand that many specific implementations can be employed to achieve the logical functionality of the invention. All such variations and modifications are intended to fall within the scope of the invention. Further, although aspects of the present invention have been described herein in the context of a particular implementation in a particular environment for a particular purpose, those of ordinary skill in the art will recognize that its usefulness is not limited thereto and that the present invention can be beneficially implemented in any number of environments for any number of purposes.

I claim:

1. A method comprising the steps of:
receiving status information in response to a condition in a system, said condition requiring notification of a potential responder;
preparing a status web feed in accordance with a web feed protocol, the status web feed including content related to the status information; and
distributing the status web feed to potential responders that subscribe to the status web feed.

2. The method of claim 1 wherein the step of receiving comprises the step of receiving the status information via a first communication network.

3. The method of claim 2 wherein the step of distributing comprises the step of distributing the status web feed via the first communication network.

4. The method of claim 2 wherein the step of distributing comprises the step of distributing the status web feed via a second communication network.

5. The method of claim 1 wherein the web feed protocol is RSS.

6. The method of claim 1 wherein the web feed protocol is ATOM.

7. The method of claim 2 wherein the step of receiving comprises the step of receiving status information by a central system, said central system coupled via the first communication network to a plurality of first systems, the step of receiving comprising receiving said status information from a first system via the first communication network.

8. The method of claim 4wherein the step of distributing comprises the step of distributing the status web feed by the central system via the second communication network.

9. The method of claim 1 wherein the system is an energy management system, and wherein the step of receiving status information comprises the step of receiving alarm information in response to a condition of the energy management system, and the step of preparing a status web feed prepares an alarm web feed including content related to the alarm.

10. The method of claim 9 wherein the alarm is related to a failure condition or an out-of-limit condition of the energy management system.

11. A method comprising the steps of:
generating by a first system status information in response to a condition in a system, said condition requiring notification of a potential responder;
sending by the first system the status information to a central management system;
preparing by the central management system a status web feed in accordance with a web feed protocol, the status web feed including content related to the status information; and
distributing by the central management system the status web feed to all potential responders that subscribe to the status web feed.

12. The method of claim 11 wherein the step of sending comprises the step of sending the status information via a first communication network.

13. The method of claim 11 wherein the step of distributing comprises the step of distributing the status web feed via the first communication network.

14. The method of claim 11 wherein the step of distributing comprises the step of distributing the status web feed via a second communication network.

15. The method of claim 11 wherein the web feed protocol is RSS.

16. The method of claim 11 wherein the web feed protocol is ATOM.

17. The method of claim 11 wherein the first system is an energy management system,
wherein the step of receiving status information comprises the step of receiving alarm information in response to a condition of the energy management system, and the step of preparing a status web feed prepares an alarm web feed including content related to the alarm.

18. The method of claim 17 wherein the alarm information is related to a failure condition or an out-of-limit condition of the energy management system.

19. A method for use in a central system coupled to a plurality of first systems via a first communication network, comprising the steps of:
receiving status information in response to a condition in a first system via the first communication network, said condition requiring notification of a potential responder;
preparing a status web feed in accordance with a web feed protocol, the status web feed including content related to the status information; and
distributing the status web feed to potential responders that subscribe to the status web feed.

20. The method of claim 19 wherein the step of distributing comprises the step of distributing the status web feed via the first communication network.

21. The method of claim 19 wherein the step of distributing comprises the step of distributing the status web feed via a second communication network.

22. The method of claim 19 wherein the web feed protocol is RSS.

23. The method of claim 19 wherein the web feed protocol is ATOM.

24. A method for use in a central energy management system coupled to a plurality of building energy management systems via a first communication network, comprising the steps of:
receiving alarm information in response to a condition of a building energy management system via the first communication network, said condition requiring notification of a potential responder;
preparing an alarm web feed in accordance with a web feed protocol, the alarm web feed including content related to the alarm information; and
distributing the alarm web feed to potential responders that subscribe to the alarm web feed.

25. The method of claim 24 wherein the step of distributing comprises the step of distributing the alarm web feed via a second communication network.

26. The method of claim 24 wherein the web feed protocol is RSS.

27. The method of claim 24 wherein the web feed protocol is ATOM.

28. A program product comprising a computer-readable medium having embodied therein a computer program for storing data, the computer program comprising:
logic for receiving status information in response to a condition in a system, said condition requiring notification of a potential responder;
logic for preparing a status web feed in accordance with a web feed protocol, the status web feed including content related to the status information; and
logic for distributing the status web feed to potential responders that subscribe to the status web feed.

29. The program product of claim 28 wherein the logic for receiving comprises logic for receiving the status information via a first communication network.

30. The program product of claim 28 wherein the logic for distributing comprises logic for distributing the status web feed via the first communication network.

31. The program product of claim 28 wherein the logic for distributing comprises logic for distributing the status web feed via a second communication network.

32. The program product of claim 28 wherein the web feed protocol is RSS.

33. The program product of claim 28 wherein the web feed protocol is ATOM.

34. The program product of claim 28 wherein logic for receiving comprises logic for receiving status information by a central system, said central system coupled via the first communication network to a plurality of first systems, the logic for receiving comprising logic for receiving said status information from a first system via the first communication network.

35. The program product of claim 28 wherein the logic for distributing comprises logic for distributing the status web feed by the central system via a second communication network.

36. A program product comprising a computer readable medium having embodied therein a computer program for storing data and the program product for use in a central system coupled to a plurality of first systems via a first communication network, the computer program comprising:
logic for receiving status information in response to a condition in a first system via the first communication network, said condition requiring notification of a potential responder;
logic for preparing a status web feed in accordance with a web feed protocol, the status web feed including content related to the status information; and
logic for distributing the status web feed to potential responders that subscribe to the status web feed.

37. The program product of claim 36 wherein the logic for distributing comprises the step of distributing the status web feed via the first communication network.

38. The program product of claim 36 wherein the logic for distributing comprises the step of distributing the status web feed via a second communication network.

39. The program product of claim 36 wherein the web feed protocol is RSS.

40. The program product of claim 36 wherein the web feed protocol is ATOM.

41. A program product comprising a computer-readable medium having embodied therein a computer program for storing data and the program product for use in a central energy management system coupled to a plurality of building energy management systems via a first communication network, the computer program comprising:
logic for receiving alarm information in response to a condition of a building energy management system via the first communication network, said condition requiring notification of a potential responder;
logic for preparing an alarm web feed in accordance with a web feed protocol, the alarm web feed including content related to the alarm; and
logic for distributing the alarm web feed to potential responders that subscribe to the alarm web feed.

42. The program product of claim 41 wherein the step of distributing comprises the step of distributing the alarm web feed via the first communication network.

43. The program product of claim 41 wherein the step of distributing comprises the step of distributing the alarm web feed via a second communication network.

44. The program product of claim 41 wherein the web feed protocol is RSS.

45. The program product of claim 41 wherein the web feed protocol is ATOM.

46. Apparatus comprising:
logic for receiving status information in response to a condition in a system, said condition requiring notification of a potential responder;
logic for preparing a status web feed in accordance with a web feed protocol, the status web feed including content related to the status information; and
logic for distributing the status web feed to potential responders that subscribe to the status web feed.

47. The apparatus of claim 46 wherein the logic for receiving comprises logic for receiving the status information via a first communication network.

48. The apparatus of claim 46 wherein the logic for distributing comprises logic for distributing the status web feed via the first communication network.

49. The apparatus of claim 46 wherein the logic for distributing comprises logic for distributing the status web feed via a second communication network.

50. The apparatus of claim 46 wherein the web feed protocol is RSS.

51. The apparatus of claim 46 wherein the web feed protocol is ATOM.

52. The apparatus of claim 46 wherein logic for receiving resides in a central system, said central system coupled via the first communication network to a plurality of first systems, the logic for receiving comprising logic for receiving said status information from a first system via the first communication network.

53. The apparatus of claim 52 wherein the logic for distributing resides in the central system and comprises logic for distributing the status web feed via the first communication network.

54. The apparatus of claim 52 wherein the logic for distributing resides in the central system and comprises logic for distributing the status web feed via a second communication network.

55. Apparatus in a central system coupled to a plurality of first systems via a first communication network, comprising:
logic for receiving status information in response to a condition in a first system via the first communication network, said condition requiring notification of a potential responder;
logic for preparing a status web feed in accordance with a web feed protocol, the status web feed including content related to the status information; and
logic for distributing the status web feed to potential responders that subscribe to the status web feed.

56. The apparatus of claim 55 wherein the logic for distributing comprises logic for distributing the status web feed via the first communication network.

57. The apparatus of claim 55 wherein the logic for distributing comprises logic for distributing the status web feed via a second communication network.

58. The apparatus of claim 55 wherein the web feed protocol is RSS.

59. The apparatus of claim 55 wherein the web feed protocol is ATOM.

60. Apparatus for use in a central energy management system coupled to a plurality of building energy management systems via a first communication network, the apparatus comprising:
logic for receiving alarm information in response to a condition of a building energy management system via the first communication network, said condition requiring notification of a potential responder;
logic for preparing an alarm web feed in accordance with a web feed protocol, the alarm web feed including content related to the alarm; and
logic for distributing the alarm web feed to potential responders that subscribe to the alarm web feed.

61. The apparatus of claim 60 wherein the step of distributing comprises the step of distributing the alarm web feed via the first communication network.

62. The apparatus of claim 60 wherein the step of distributing comprises the step of distributing the alarm web feed via a second communication network.

63. The apparatus of claim 60 wherein the web feed protocol is RSS.

64. The apparatus of claim 60 wherein the web feed protocol is ATOM.
